(19) United States
(12) Patent Application Publication
(10) Pub. No.: US 2006/0027252 A1
(43) Pub. Date: Feb. 9, 2006

(54) Methods of processing substrates during semiconductor manufacturing processes

(75) Inventors: Chang-Sup Mun, Incheon-Gwangyeoksi (KR); Chang-Ki Hong, Gyeonggi-do (KR); Sang-Jun Choi, Seoul (KR); Hyung-Ho Ko, Seoul (KR); Sang-Yong Kim, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/193,088

(22) Filed: Jul. 29, 2005

(30) Foreign Application Priority Data
Aug. 3, 2004 (KR) 10-2004-0061232

(51) Int. Cl. B08B 3/00

(52) U.S. Cl. 134/28; 134/26

(57) ABSTRACT

The present invention provides methods of processing a substrate by contacting the substrate with an inorganic solution including an organic additive, rinsing the substrate with an organic alcohol, and rinsing the substrate with deionized water. Related substrates and devices are also disclosed.

### CROSS-REFERENCE TO RELATED APPLICATION

This application claims priority to Korean Patent Application No. 2004-61232, filed Aug. 3, 2004, the disclosure of which is incorporated herein by reference in its entirety.

### FIELD OF THE INVENTION

The present invention relates to manufacturing processes, and more particularly, to methods of processing a substrate during semiconductor manufacturing processes.

### BACKGROUND OF THE INVENTION

During the processes of manufacturing a semiconductor device, a substrate may be cleaned with either an inorganic cleaning solution, such as sulfuric acid, hydrogen peroxide, hydrofluoric acid, or ammonia; or an organic cleaning solution, such as an organic amine. After cleaning the substrate, in order to remove contaminants or oxide films, the substrate may be rinsed to remove any residual cleaning solution. For example, when the substrate is cleaned with an inorganic cleaning solution, the substrate may be rinsed with deionized water. When the substrate is cleaned with an organic cleaning solution, the substrate may be rinsed with isopropyl alcohol.

In general, since the inorganic cleaning solution may have a high surface tension, an organic surface-active agent may be added to the cleaning solution to enable the cleaning solution to permeate into minute structures. In addition, an organic corrosion inhibitor may be added to the inorganic cleaning solution to limit metal corrosion during post-chemical mechanical polishing (CMP) cleaning. After removing contaminants from the substrate using the inorganic cleaning solution including an organic additive, the substrate may be rinsed with deionized water and dried in order to remove residual cleaning solution. At this point, the organic surface active agent and/or organic corrosion inhibitor adsorbed to the surface of a silicon nitride, polysilicon, silicon-germanium, or silicon oxide film may form a hydrophobic layer such that the organic surface active agent or organic corrosion inhibitor resides at the surface of the substrate even after the substrate is rinsed with deionized water. Moreover, the hydrophobic layer may prevent the deionized water from spreading uniformly, and thus, water spots may be formed upon drying the substrate.

### SUMMARY OF THE INVENTION

Embodiments according to the present invention may provide substrate processing methods that remove or reduce residue from a substrate by contacting the substrate with an inorganic solution.

In particular, some embodiments of the present invention provide methods of processing a substrate including contacting the substrate with an inorganic solution including an organic additive, rinsing the substrate with an organic alcohol, and rinsing the substrate with deionized water. In some embodiments, the inorganic solution may be a water-soluble solution including an organic surface-active agent. In some embodiments, the organic additive includes an organic corrosion inhibitor and may further include a surface-active agent.

According to some embodiments of the present invention, the substrate may be further subjected to a chemical mechanical polishing (CMP) process. In some embodiments, the substrate may be subjected to a post-CMP process.

In some embodiments, the present invention provides substrates processed according to the methods described herein and devices comprising the substrates.

### BRIEF DESCRIPTION OF THE DRAWINGS

FIG. 1 presents a flowchart showing methods of processing a substrate according to some embodiments of the present invention; and

FIG. 2 presents a flowchart showing methods of processing a substrate according to some embodiments of the present invention.

### DETAILED DESCRIPTION OF EMBODIMENTS ACCORDING TO THE INVENTION

Embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

Unless otherwise defined, all terms, including technical and scientific terms used in the description of the invention, have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Moreover, it will be understood that steps comprising the methods provided herein can be performed independently or at least two steps can be combined, unless specified. Additionally, steps comprising the methods provided herein, when performed independently or combined, can be performed at the same temperature and/or atmospheric pressure or at different temperatures and/or atmospheric pressures, unless specified, without departing from the teachings of the present invention. Additionally, like numbers refer to like compositions or elements throughout.

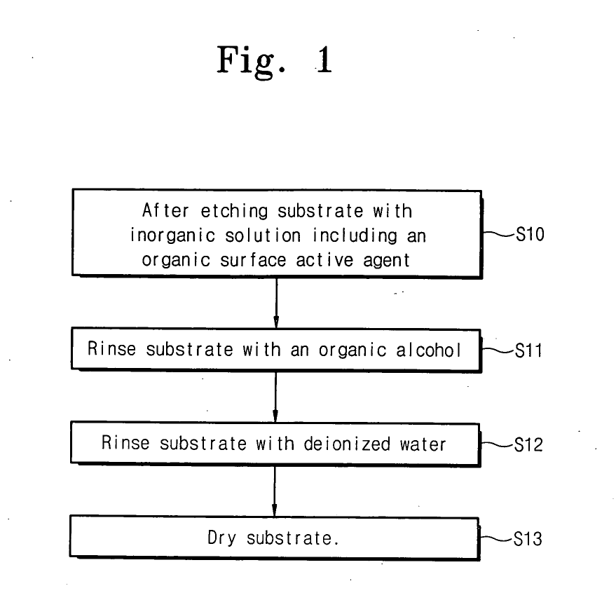

In some embodiments, the present invention provides methods of processing a substrate. Referring to FIG. 1, after an insulating or conductive film on a substrate is etched to pattern the insulating or conductive film, a cleaning process is performed to remove impurities or contaminants on the surface of the substrate (S10). After performing the etching process, the substrate is cleaned with a water-soluble inorganic cleaning solution. An organic surface-active agent is added to the water-soluble inorganic cleaning solution in order for the cleaning solution to permeate into minute patterns. An anionic, cationic, amphoteric, or non-ionic surface active agent may be added to water-soluble inorganic cleaning solutions such as sulfuric acid, hydrogen peroxide, ammonia, hydrofluoric acid and the like. In particular, cationic surface-active agents, such as cetyl trimethyl ammonium bromide (CTAB), poly(oxyethylene)alkylamine, tetraalkylammonium, alkylammoniumfluoride, octylammoniumchloride and the like may be utilized because these agents may minimize air bubbles. When the surface-active agent is added, the inorganic cleaning solution may permeate into minute patterns such that it is possible to remove contaminants within the minute patterns. However, the surface-active agent may become adsorbed to the surface of a silicon nitride, silicon oxide, polysilicon, or silicon-germanium film and may form a hydrophobic layer.

In some embodiments, a substrate having a silicon oxide film of about 1,000 Å may be treated for about one minute with a cleaning solution obtained by adding about 0.1% CTAB to a water-soluble inorganic cleaning solution formed from about a 200:1 mixture of deionized water and about 50% hydrofluoric acid. This treatment may cause the surface of the silicon oxide film to change from hydrophilic to hydrophobic.

In some embodiments, the substrate may be rinsed with an organic alcohol (S11). The organic alcohol may have the chemical structure of either formula 1 or 2:
R₁—OH [FORMULA 1]

wherein R₁ represents a linear or branched aliphatic or a cycloaliphatic group. In some embodiments, R₁ may represent methyl, ethyl, propyl, or isopropyl; or
XO—(Y—O)ₙ—H [FORMULA 2]

wherein:

X represents hydrogen, a linear or branched aliphatic or a cycloaliphatic group;

Y represents a linear or branched alkylene group having from 1 to 8 carbon atoms; and

n represents an integer from 1 to 20.

In some embodiments, X represents hydrogen, methyl, ethyl, propyl, isopropyl, butyl, or isobutyl. In further embodiments, Y represents —(CH₂)₂—, —(CH₂)₃—, —CH(CH₃)CH₂— or —(CH₂)₄—. In some embodiments, n represents an integer from 1 to 20.

According to some embodiments of the present invention, the organic alcohol may be a liquid at a given room temperature. Additionally, in some embodiments, the process of rinsing the substrate with the organic alcohol may be performed at any temperature in a range from between about the melting point and about the flash point of the alcohol used. Further, after rinsing the substrate with the organic alcohol, the substrate may be rinsed with deionized water (S12) and dried (S13). When the substrate is rinsed with deionized water alone, a hydrophobic layer may remain at the surface of the substrate. Additionally, the deionized water may not uniformly spread on the surface of the substrate, and water spots may be formed upon drying the substrate. However, the generation of the water spots may be prevented or reduced by sequentially performing a primary rinsing process using the organic alcohol and a secondary rinsing process using deionized water. Thus, in some embodiments, rinsing the substrate with deionized water is preceded by rinsing the substrate with the organic alcohol.

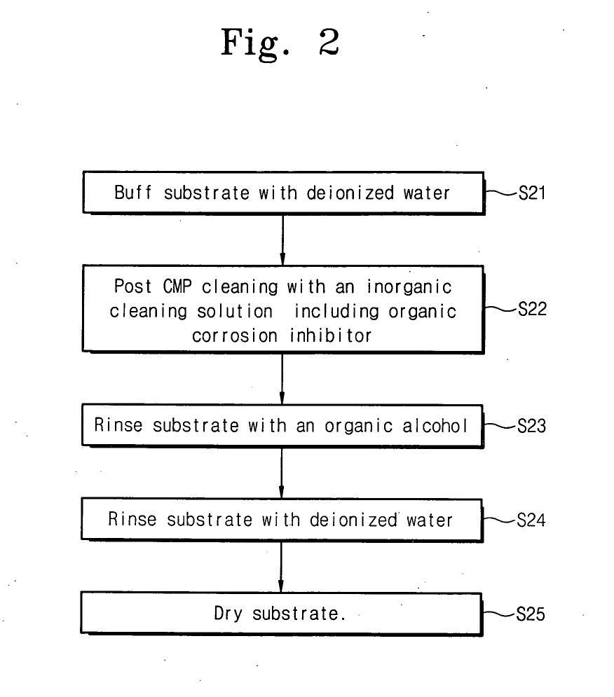

According to further embodiments of the present invention, chemical mechanical polishing (CMP) may be used for planarizing the surface of a substrate or for polishing a metal film until an insulating film is exposed to form a metal pattern. During the CMP process, a surface-active agent, such as those surface-active agents described above, may be included in the slurry for polishing the substrate. Referring to FIG. 2, the substrate on which the CMP process is performed undergoes a buffing process in which residual slurry and polish residues are removed with deionized water before being dried (S21). The buffing process may remove most of the slurry and polish residues, and then remaining contaminants may be removed with post-CMP cleaning with an inorganic cleaning solution (S22). In order to prevent or reduce the metal film from corroding during the post-CMP cleaning, an organic corrosion inhibitor may be added to the inorganic cleaning solution. In some embodiments, aromatic hydroxy compounds, acetylene alcohol, triazole compounds, and isothiazolines may be used as organic corrosion inhibitors. When the organic corrosion inhibitor is added to the cleaning solution, it may be possible to prevent metal corrosion. However, the organic corrosion inhibitor may also adsorb to the surface of the silicon oxide film that insulates the metal pattern and a hydrophobic layer may be formed.

The substrate upon which the post-CMP cleaning is performed may then be moved to a spinner or water tank to be rinsed with an organic alcohol (S23). The organic alcohol may have the structures of chemical formulas 1 and 2, described above. In some embodiments, the organic alcohol used may be a liquid at a given room temperature. The process of rinsing the substrate with the organic alcohol may be performed at a temperature in a range between about the melting point and about the flash point of the alcohol used.

After rinsing the substrate with the organic alcohol, the substrate may be rinsed with deionized water (S24) and dried (S25). In some embodiments, after cleaning the substrate with an inorganic cleaning solution including an organic additive, the organic additive may become adsorbed to the surface of the substrate to form a hydrophobic layer on the surface of the substrate. The substrate may be sequentially rinsed with the organic alcohol and deionized water to remove the hydrophobic layer formed on the substrate. Thus, in some embodiments, rinsing the substrate with deionized water is preceded by rinsing the substrate with the organic alcohol. Accordingly, when an organic surface active agent is added to the inorganic cleaning solution, the solution may permeate into the minute patterns. When an organic corrosion inhibitor is added to the inorganic cleaning solution, corrosion of the metal may be reduced or prevented. Consequently, the resulting hydrophobic film may be removed, thus preventing or reducing residue or water spots from forming on the surface of the substrate.

What is claimed is:

1. A method of processing a substrate comprising:
contacting the substrate with an inorganic solution comprising an organic additive;
rinsing the substrate with an organic alcohol; and
rinsing the substrate with deionized water.

2. The method of claim 1, wherein the inorganic solution comprises sulfuric acid, hydrogen peroxide, ammonia or hydrofluoric acid.

3. The method of claim 1, wherein the inorganic solution is a water-soluble solution comprising an organic surface-active agent.

4. The method of claim 3, wherein the organic surface-active agent is an anionic, cationic, amphoteric or non-ionic surface-active agent.

5. The method of claim 3, wherein the organic surface active agent is a cationic surface-active agent.

6. The method of claim 5, wherein the cationic surface-active agent comprises cetyl trimethyl ammonium bromide (CTAB), poly(oxyethylene)alkylamine, tetraalkylammonium, alkylammoniumfluoride, or octylammoniumchloride.

7. The method of claim 6, wherein the inorganic solution is obtained by adding CTAB to a solution that is about a 200:1 mixture of deionized water and about 50% hydrofluoric acid.

8. The method of claim 1, wherein the organic additive comprises an organic corrosion inhibitor.

9. The method of claim 8, wherein the organic additive further comprises a surface active agent.

10. The method of claim 8, wherein the organic corrosion inhibitor comprises an aromatic hydroxy compound, an acetylene alcohol, a triazole compound, or an isothiazoline compound.

11. The method of claim 1, wherein the organic alcohol has a structure represented by the following chemical formula:
R₁—OH
wherein R₁ is a linear or branched aliphatic or a cycloaliphatic group.

12. The method of claim 11, wherein R₁ is methyl, ethyl, propyl, or isopropyl.

13. The method of claim 1, wherein the organic alcohol has a structure represented by the following chemical formula:
XO—(Y—O)ₙ—H
wherein:
X is hydrogen, a linear or branched aliphatic or a cycloaliphatic group;
Y is a linear or branched alkylene group having from 1 to 8 carbon atoms; and
n is an integer from 1 to 20.

14. The method of claim 13, wherein X is hydrogen, methyl, ethyl, propyl, isopropyl, butyl, or isobutyl; and Y is —(CH₂)₂—, —(CH₂)₃—, —CH(CH₃)CH₂— or —(CH₂)₄—.

15. The method of claim 1, wherein rinsing the substrate with the organic alcohol is carried out at a temperature that is no less than about the melting point of the organic alcohol.

16. The method of claim 1, wherein rinsing the substrate with the organic alcohol is carried out at a temperature that is no greater than about the flash point of the organic alcohol.

17. The method of claim 1, wherein rinsing the substrate with the deionized water is preceded by rinsing the substrate with the organic alcohol.

18. The method of claim 1, wherein the substrate is further subjected to a buffing process to remove contaminants.

19. The method of claim 1, wherein the substrate is subjected to a chemical mechanical polishing (CMP) process.

20. The method of claim 19, wherein the CMP process comprises subjecting the substrate to a composition comprising a surface active agent.

21. The method of claim 19, wherein the substrate is subjected to a post-CMP process comprising rinsing the substrate with an inorganic solution.

22. The method of claim 21, wherein the inorganic solution comprises an organic corrosion inhibitor.
